(19) United States
(12) Patent Application Publication
(10) Pub. No.: US 2003/0003351 A1
(43) Pub. Date: Jan. 2, 2003

(54) Secondary battery

(76) Inventors: Yoshiaki Ogata, Toyohashi (JP); Toyohiko Etoh, Toyota (JP)

Correspondence Address: SNELL & WILMER, ONE ARIZONA CENTER, 400 EAST VAN BUREN, PHOENIX, AZ, 850040001

(21) Appl. No.: 10/188,729

(22) Filed: Jul. 2, 2002

(30) Foreign Application Priority Data
Jul. 2, 2001 (JP) 2001-200855

(51) Int. Cl. H01M 10/50; H01M 2/02

(52) U.S. Cl. 429/120; 429/176

(57) ABSTRACT

A secondary battery comprising: a battery case formed of a synthetic resin and formed into a thin rectangular-parallelepiped shape, and whose inner space is divided into a plurality of reaction chambers by walls formed with an appropriate space therebetween in a width direction; and a plurality of radiators respectively provided on a surface along the width direction of the battery case so as to correspond to the reaction chambers is provided.

### BACKGROUND OF THE INVENTION

1. Field of the Invention

The present invention relates to a secondary battery used in an electric vehicle or the like. Specifically, the present invention relates to a thin rectangular-parallelepiped shaped secondary battery having an improved cooling efficiency.

2. Description of the Related Art

A secondary battery which can be repeatedly charged and discharged is used as a power source of a motor in various types of electric vehicles, for example, a hybrid electric vehicle or the like. A secondary battery, when used in an electric vehicle, is required to have a large capacity of electricity and a high voltage. Therefore, a plurality of secondary batteries are combined to form a battery pack and the battery pack is mounted in a vehicle.

FIG. 13 is a perspective view showing an exemplary secondary battery 200 which forms a battery pack to be mounted in an electric vehicle. The secondary battery 200 has a battery case 50. The battery case 50 has a battery case body 51 formed into a thin rectangular-parallelepiped shape having an open top and a strip-like cover 53 for covering the open top of the battery case body 51.

The thin rectangular-parallelepiped shaped battery case 50 has a small thickness D2, a height H greater than the thickness D2, and a width W greater than the height H.

An inner space of the battery case body 51 is divided into, for example, six reaction chambers by five walls extending in the thickness D2 direction, equally spaced in the width W direction. Each of the reaction chambers contains a plurality of positive plates and a plurality of negative plates which extend in the width W direction of the battery case 50.

In each reaction chamber, the positive plates and the negative plates are provided, being insulated from each other by separators. All the positive plates in the reaction chamber are connected to a positive pole collector plate extending in the thickness D2 direction. All the negative plates in the reaction chamber are connected to a negative pole collector plate extending in the thickness D2 direction. The positive pole collector plate and the negative pole collector plate oppose each other within the reactive chamber with all the positive plates and the negative plates interposed therebetween. All the positive plates and the negative plates, and the collector plates are in contact with an electrolyte in the reaction chamber.

On a side surface 51x of the battery case body 51, a terminal 55a of the positive pole is provided. This terminal 55a is serially connected to the positive pole collector plate positioned in the reaction chamber adjacent to the surface 51x. On another side surface 51y of the battery case body 51, a terminal 55b of the negative pole is provided. This terminal 55b is serially connected to the collector plate of the negative pole positioned in the reaction chamber adjacent to the surface 51y. The positive pole collector plate and the negative pole collector plate are serially connected to the respective positive pole collector plate and the negative pole collector plate in an adjacent reaction chamber.

A plurality of the secondary batteries 200 having the above-described structure are stacked side-by-side in the thickness D2 direction and connected in series or in parallel to each other to form a battery pack. The battery pack is mounted in an electric vehicle.

The secondary battery 200 has a problem that, due to a reaction resistance caused by a battery reaction and component resistance caused by collecting electricity and connection between the components, a temperature in the reaction chamber rises and thus a temperature of the battery case 50 rises. Especially, when a large amount of current is charged and/or discharged, temperature of the battery case 50 rises significantly. If the temperature in the reaction chamber rises, battery reaction in the reaction chamber is weakened. Thus, cooling air is supplied and passed through the space between a pair of stacked secondary batteries in the height H direction (e.g., from the bottom to the top of the battery case 50 in FIG. 13) to cool the battery case 50 of the secondary battery.

A secondary battery 200 has ribs 54 which extend in the height H direction on each surface 51b along the width W direction of the battery case body 51 with a certain space therebetween in the width W direction for smoothly passing the cooling air through the spaces between the pair of the stacked secondary batteries. By keeping the ribs 54 of one secondary battery in contact with those of an adjacent secondary battery in a structure in which the batteries 200 are stacked side-by-side, spaces for passing the cooling air are formed between the surfaces 51b of the secondary batteries 200. The secondary battery 200 is cooled by passing the cooling air through these spaces.

A number of protrusions 51a are provided on the surfaces 51b of the battery case body 51 to improve a resistance of the secondary battery 200 against pressure.

In recent years, for improving a power output of such a thin rectangular-parallelepiped shaped secondary battery 200 at a low temperature, the capacity of the secondary battery 200 is increased by increasing only the thickness D2 of the battery case 50 to increase the number of the plates contained in each reaction chamber.

However, such an attempt to increase the capacity causes a problem that the temperature in the each reaction chamber is further raised by the heat of reaction. As described above, in such a secondary battery 200, each reaction chamber is cooled by passing the cooling air along the surfaces 51b of the battery case 51. If only the thickness D2 of the battery case 51 of the secondary battery 200 is increased, an area for radiating heat due to cooling air does not increase. Thus, each chamber cannot be sufficiently cooled.

### SUMMARY OF THE INVENTION

According to one aspect of the present invention, there is provided a secondary battery comprising: a battery case formed of a synthetic resin and formed into a thin rectangular-parallelepiped shape, and whose inner space is divided into a plurality of reaction chambers by walls formed with an appropriate space therebetween in a width direction; and a plurality of radiators respectively provided on a surface along the width direction of the battery case so as to correspond to the reaction chambers.

In one embodiment of the present invention, each of the radiators is formed of a metal plate which has a high heat conductivity.

In one embodiment of the present invention, the radiators are integrally formed with the battery case by insert molding.

In one embodiment of the present invention, a plurality of grooves extending in the width direction of the battery case and a plurality of grooves extending in a height direction are provided on a surface of each radiator.

In one embodiment of the present invention, each of the radiators is formed of a plurality of radiation pieces located along the width direction of the battery case and the height direction.

In one embodiment of the present invention, each of the radiators comprises a plurality of convex stripes extending in the height direction of the battery case.

In one embodiment of the present invention, the convex stripes of each of the radiators protrude from the surface along the width direction of the battery case.

Thus, the invention described herein makes possible the advantages of providing a secondary battery in which it is capable to cool a battery case even if a thickness of the battery case is increased.

These and other advantages of the present invention will become apparent to those skilled in the art upon reading and understanding the following detailed description with reference to the accompanying figures.

### BRIEF DESCRIPTION OF THE DRAWINGS

FIG. 1 is a perspective view showing an example of a secondary battery according to the present invention.

FIG. 2 is a perspective view showing a radiator used in the secondary battery of FIG. 1.

FIG. 3 is across-sectional view showing a portion of the combined secondary batteries of FIG. 1.

FIG. 4 is a perspective view showing another radiator used in the secondary battery according to the present invention.

FIG. 5 is an enlarged view of the portion indicated by A in FIG. 4.

FIG. 6 is a perspective view showing another example of the radiator used in the secondary battery according to the present invention.

FIG. 7 is an enlarged view of the portion indicated by B in FIG. 6.

FIG. 8 is a perspective view showing yet another radiator used in the secondary battery according to the present invention.

FIG. 9 is an enlarged view of the portion indicated by C in FIG. 8.

FIG. 10 is a perspective view showing a portion of yet another radiator used in the secondary battery according to the present invention.

FIG. 11 is a cross-sectional view of an essential portion of the combined secondary batteries used in the secondary battery according to the present invention.

FIG. 12 is a cross-sectional view of an essential portion of the combined secondary batteries used in the secondary battery according to the present invention.

FIG. 13 is a perspective view showing an example of a conventional secondary battery.

### DESCRIPTION OF THE PREFERRED EMBODIMENTS

Hereinafter, examples of the present invention will be described with reference to the drawings.

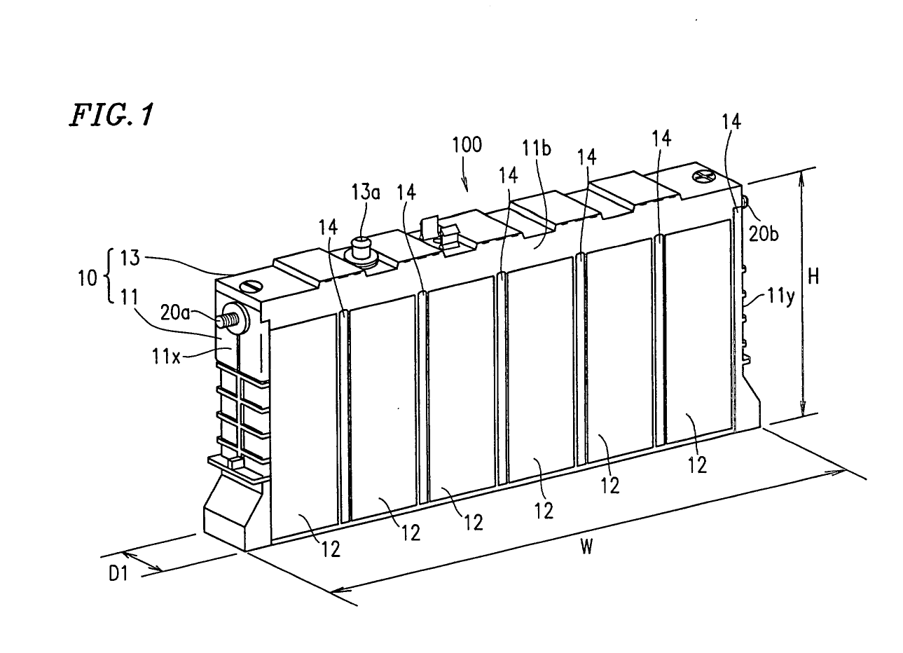

FIG. 1 is a perspective view showing an exemplary secondary battery 100 according to an example of the present invention. The secondary battery 100 is a Nickel-metal hydride battery, for example. A plurality of the secondary batteries 100 are combined to be used as a power source of a motor in an electric vehicle. As shown in FIG. 1, the secondary battery comprises a battery case 10. The battery case 10 contains pole plates and an electrolyte. The battery case 10 has a thin rectangular-parallelepiped shaped battery case body 11 having an open top and a strip-like cover 13 for covering the open top of the battery case body 11.

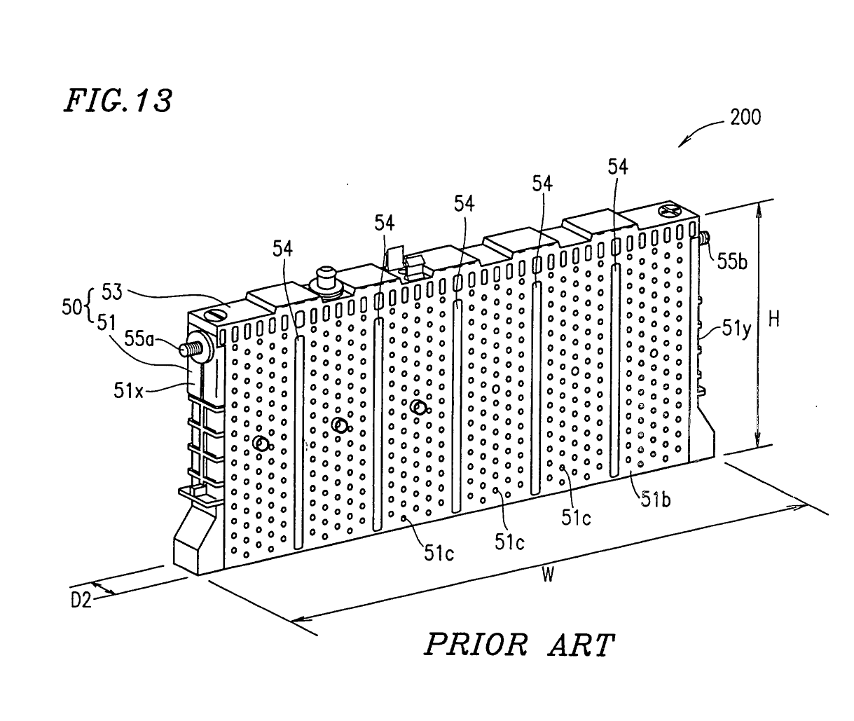

The battery case 10 is integrally formed of a synthetic resin. A thickness D1 of the battery case 10 is twice as large as the thickness D2 of the conventional thin rectangular-parallelepiped shaped secondary battery shown in FIG. 13 so as to increase a power output of the secondary battery 100 while maintaining a low temperature. A height H and a width W of the battery case 10 are approximately equal to the height H and the width W of the conventional battery case 50 shown in FIG. 13. The height H is greater than the thickness D1 and the width W is greater than the height H.

An inner space of the battery case body 11 is divided into, for example, six reaction chambers by five walls extending in the thickness D1 direction, equally spaced in the width W direction. Each of the reaction chambers contains a plurality of positive plates and a plurality of negative plates which extend in the width W direction of the battery case 10.

In each reaction chamber, the positive plates and the negative plates are provided, being insulated from each other by separators. All the positive plates in the reaction chamber are connected to a positive pole collector plate extending in the thickness D1 direction. All the negative plates in the reaction chamber are connected to a negative pole collector plate extending in the thickness D1 direction. The positive pole collector plate and the negative pole collector plate oppose to each other within the reactive chamber with all the positive plates and the negative plates interposed therebetween. All the positive plates and the negative plates, and the collector plates are in contact with an electrolyte in the reaction chamber.

On a side surface 11x of the battery case body 11, a terminal 20a of the positive pole is provided. This terminal 20a is serially connected to the positive pole collector plate positioned in the reaction chamber adjacent to the surface 11x. On another side surface 11y of the battery case body 11, a terminal 20b of the negative pole is provided. This terminal 20b is serially connected to the negative pole collector plate positioned in the reaction chamber adjacent to the surface 11y. The positive pole collector plates and the negative pole collector plates in the reaction chambers are serially connected to each other except for the reaction chambers located on both ends (in the width W direction) of the battery case 10, whose collector plates are connected to the terminals 20a and 20b, respectively.

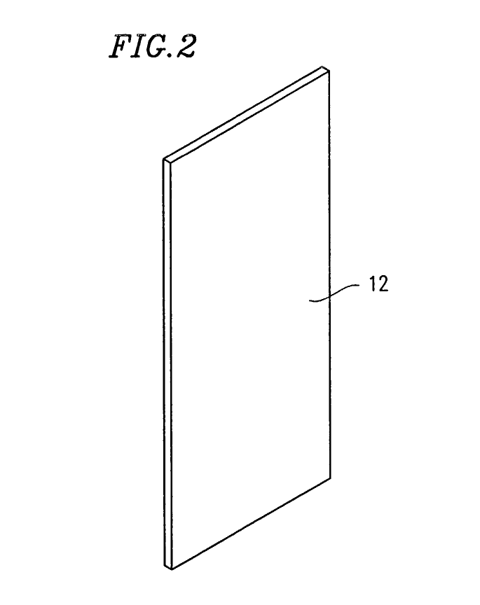

On a side surface(s) 11b of the battery case body 11 along the width W direction, ribs 14 extending in the height H direction (e.g., from the bottom to the top of the battery case 10 in FIG. 1) are provided so as to correspond to walls provided inside the battery case body 11. The ribs 14 extending in the height H direction are also provided on edge areas of the side surfaces 11b, which are close to the side surfaces 11x and 11y, in the battery case body 11. Between a pair of the ribs 14 located adjacent to each other, a radiator 12 as shown in FIG. 2 is provided.

The radiators 12 are formed of a metal plate such as aluminum or stainless steel, which has a high heat conductivity, and formed into a rectangular shape in a corresponding size on an inner surface along width W direction in a reaction chamber provided in the battery case body 11. An entire surface of the radiator 12 is flat.

The radiators 12 are buried into surfaces 11b of the battery case body 11 so as to oppose the reaction chambers by using, for example, insert molding.

The cover 13 provided on top of the battery case body 11 is formed of a synthetic resin similar to that used for the battery case body 11 so as to be in a strip form and integrally attached to an upper portion of the battery case body 11. The cover 13 comprises a gas emitting outlet 13a for venting internal gas to the outside when the inner pressure in the reactive chamber rises to a predetermined value or above.

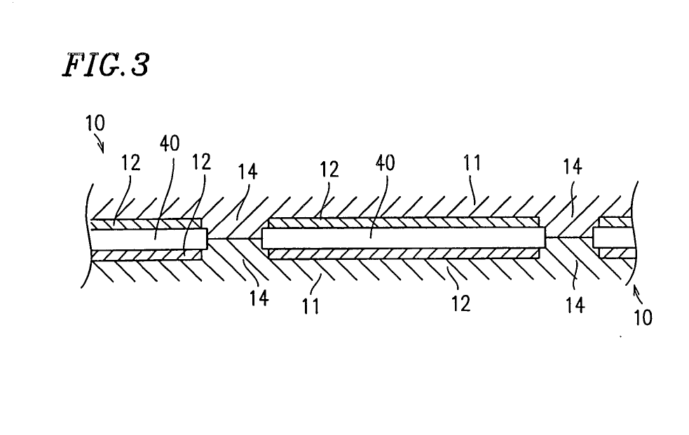

A plurality of the secondary batteries 100 having the above-described structure are stacked side-by-side in the thickness D1 direction of the battery case 10 and the stacked secondary batteries are connected in series or in parallel to each other to form a battery pack. In such a structure, the secondary batteries are stacked side-by-side so that the ribs 14 provided on one secondary battery are in contact with those provided on an opposing secondary battery. FIG. 3 is a cross-sectional view showing a portion of the combined secondary batteries. As shown in FIG. 3, spaces 40 are formed between the stacked secondary batteries 100, and between a pair of the ribs 14 contacting each other and an adjacent pair of the ribs 14 contacting each other.

In the battery pack comprising a number of secondary batteries 100 combined with each other, cooling air for cooling the secondary batteries 100 is provided toward the lower portion of the secondary battery 100. The cooling air provided toward the lower portion of the secondary battery 100 passes through the spaces 40 between a pair of stacked secondary batteries 100 from the bottom to the top (i.e., in relation to FIG. 1). Thus, the secondary batteries 100 located on both sides of the spaces 40 are cooled by the cooling air.

The radiators 12 attached to the surfaces 11b of the battery cases 10 of the secondary batteries 100 are in contact with the spaces 40 through which the cooling air passes. Therefore, the cooling air which flows through the spaces 40 efficiently cools down the radiators 12, and thus the surfaces 11b of the battery cases 10 of the secondary batteries 100 to which the radiators 12 are attached can be efficiently cooled.

The secondary battery 100 shown in FIG. 1 has a relatively large thickness D1 of the battery case 10 and the number of positive plates and the negative plates contained in the reaction chambers of the battery case 10 is relatively increased with respect to the conventional secondary batteries. Thus, the current for charging and/or discharging the battery increases and temperature rise in the reaction chamber is promoted. However, since the radiators 12 are provided on the surfaces 11b of the battery case 10 so as to correspond to the reaction chambers, the radiators 12 are efficiently cooled by the cooling air passing through the spaces 40. Thus, the surfaces 11b of the battery case 10 are efficiently cooled. The cooling of the reaction chambers is promoted. As a result, the temperature rise in the reaction chamber is suppressed.

As described above, the secondary battery 100 according to the present invention ensures suppression of the temperature rise in the reaction chamber even if the thickness D1 is increased and the temperature rise in the reaction chambers is promoted. Therefore, the secondary battery 100 according to the present invention can be used in a stable manner for a long time.

The surfaces 11b of the battery case body 11 of the battery case 10 which is made of a synthetic resin are covered with the radiators 12 which are made of metal. Thus, moisture or hydrogen gas in the reaction chambers is prevented from permeating the surfaces 11b of the battery case body made of a synthetic resin and leaking out of the reaction chambers. Therefore, the secondary battery 100 according to the present invention can be used in an increased stable manner for a long time.

The radiators 12 provided so as to correspond to the reaction chambers extend in the height H direction which is a direction for passing through the cooling air. In the reaction chambers, for example, a temperature at the upper portion maybe higher than the temperature at the lower portion due to the temperature rise. However, since the cooling air passes from the bottom to the top of the secondary battery and the radiators 12 having a high heat conductivity radiate heat in a uniform manner, the temperatures in the reaction chambers can be uniformalized throughout the reaction chambers. When the radiators 12 are not provided for each of the reaction chambers, and the cooling air is not provided, the battery case 10 has maximum temperature of 50° C. at the upper portion and 40° C. at the lower portion. However, by providing the radiators 12 and passing the cooling air from the bottom to the top, the maximum temperature is uniformalized to about 45° C. throughout the whole battery case 10.

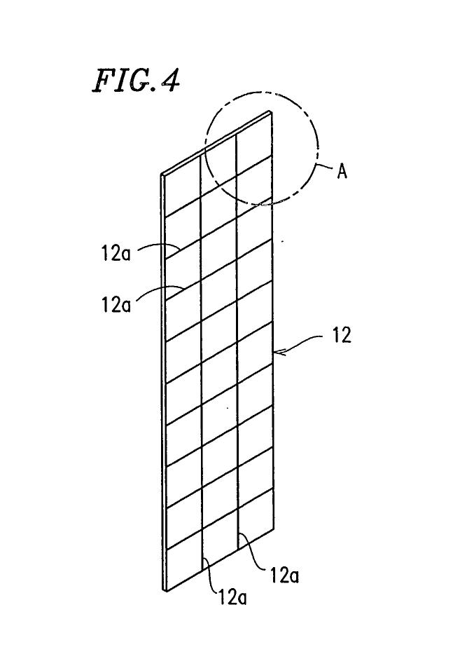

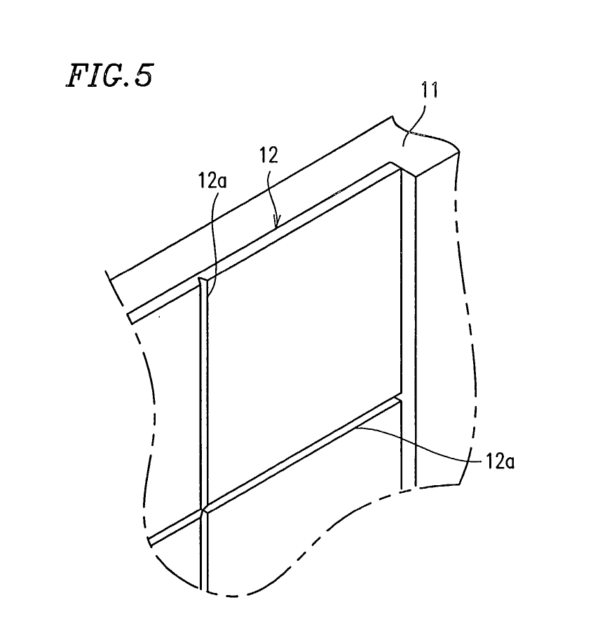

FIG. 4 is a perspective view showing another example of the radiator 12. FIG. 5 is an enlarged view of a portion indicated by A in FIG. 4. As described above, the radiators 12 are formed of a metal plate, such as aluminum, which has a high conductivity, and formed into a rectangle shape of a predetermined size. On both side surfaces, grooves 12a having V-shape cross-sections are provided along the height H direction and the width W direction with a certain space therebetween. The cross sections of grooves 12a are not limited to V-shape. The cross sections of grooves 12a can be U-shape, or another similar shape.

The radiators 12 having the above-described structure are attached to the surfaces 11b of the battery case body 11 of the battery case 10 of the secondary battery 100 so as to correspond to the respective reaction chambers. Therefore, the battery case 10 can be efficiently cooled by the radiators 12 attached to the surfaces 11b and can be used in a stable manner for a long time.

If the pressure in the reaction chambers increases due to an electrochemical reaction occurs in the reaction chamber, the battery case 10 may bend in the width W direction, for example. In the battery case 10, on the surfaces 11b of the battery case body 11, a plurality of the radiators 12 are located in parallel along the width W direction. Each radiator 12 has the grooves 12a extending in the width W direction or the height H direction. Therefore, the radiators 12 bends so as to conform to the bend in the battery case body 11. Therefore, the radiators 12 are not peeled off from the surfaces 11b of the battery case body 11 and the radiators 12 are not damaged.

Even when the battery case body 11 of the battery case 10 bends along the height H direction, since the radiators 12 comprise the grooves 12a extending in the width W direction, the radiators 12 bend so as to conform the bend along the height H direction of the battery case body 11. Therefore, the radiators 12 is not be peeled off from the surfaces 11b of the battery case body 11 and the radiators 12 may not be damaged.

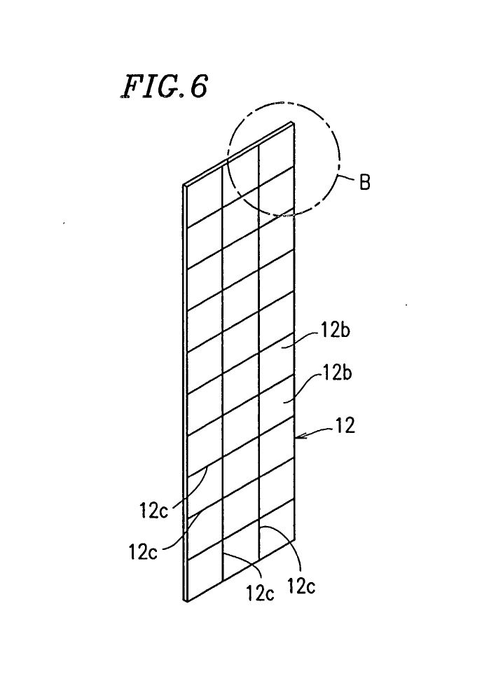

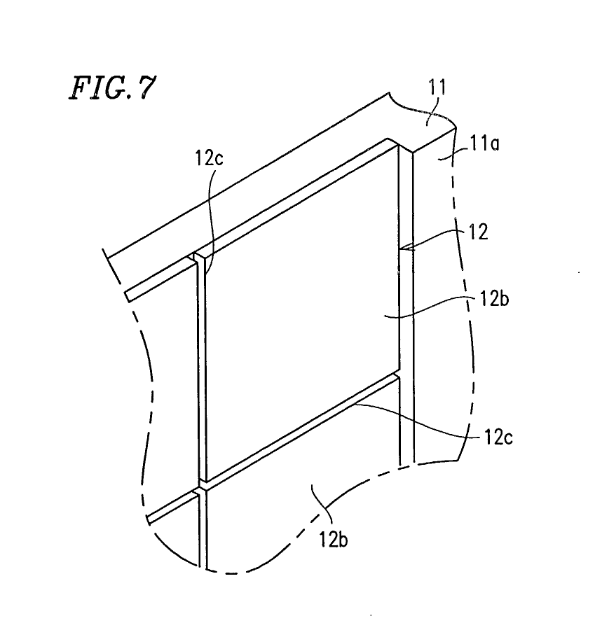

FIG. 6 is a perspective view showing another example of the radiator 12. FIG. 7 is an enlarged view of a portion indicated by B in FIG. 6. The radiators 12 are formed of a number of radiation pieces 12b formed of a metal plate such as aluminum, which has a high heat conductivity. On areas corresponding to the respective reaction chambers on the surfaces 11b of the battery case body 11, the radiation pieces 12b are provided in a grid pattern along the height H direction and the width W direction, with slits 12c therebetween, and buried into the surfaces 11b.

Thus, since the radiators 12 are formed of a number of the radiation pieces 12b separated from each other, the radiators 12 further conforms to the bend of the battery case body 11. Since the radiators 12 are separated from each other, even if the battery case body 11 bends, the radiators 12 are not damaged.

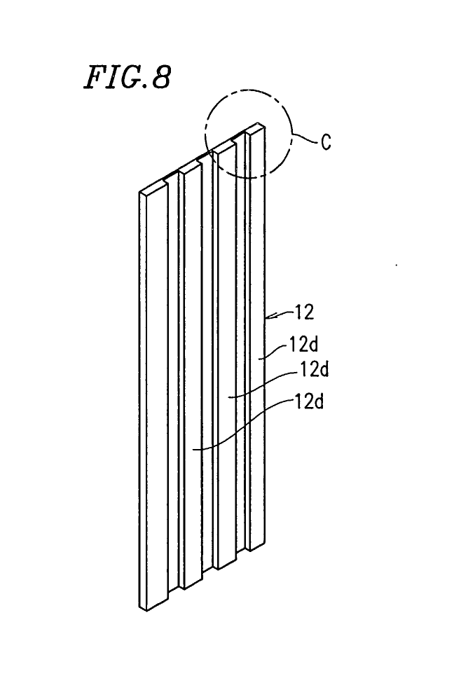

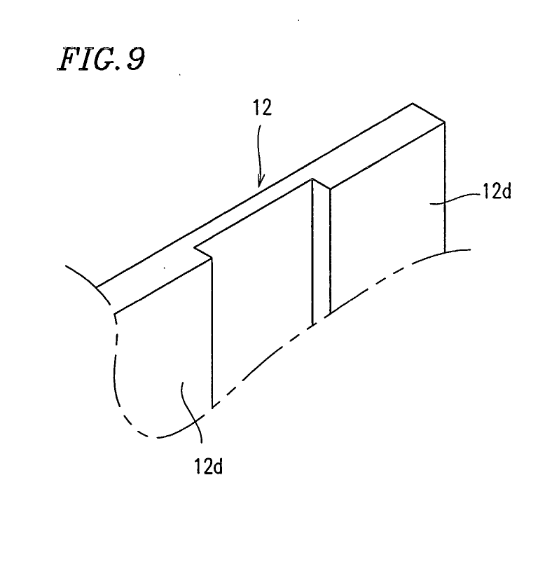

FIG. 8 is a perspective view showing yet another example of the radiator 12. FIG. 9 is an enlarged view of a portion indicated by C in FIG. 8. The radiators 12 are formed of a metal plate, such as aluminum, which has a high heat conductivity. On a surface which is in contact with the spaces 40 when the secondary batteries 100 are stacked side-by-side, a plurality of convex stripes 12d extending in the height H direction are provided with an equal space therebetween in the width W direction. For example, the convex stripes 12d are formed by cutting grooves having constant widths along the height H direction in a surface of a metal plate. In the battery case body 11 having such a structure, since the radiators 12 are buried into the surfaces 11b of the battery case body 11, the convex stripes 12d are not protruded from the surfaces 11b of the battery case body 11.

In the radiators 12 having the above-described structure, the convex stripes 12d are located in the spaces 40 formed by stacking a pair of the secondary batteries 100 side-by-side. Therefore, the surface area of the radiators 12 to be in contact with the cooling air flowing through the spaces 40 increases and the radiators 12 are efficiently cooled.

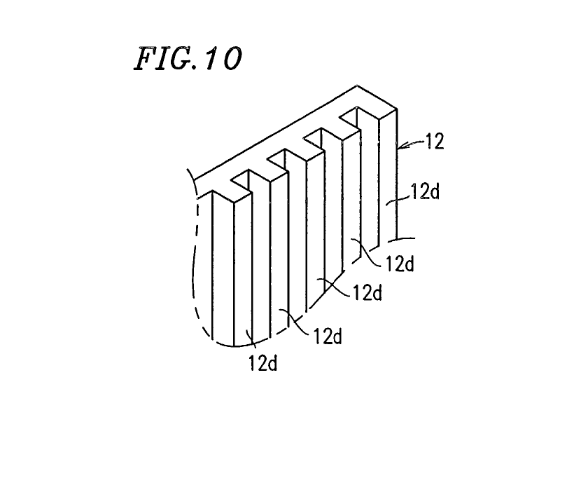

FIG. 10 is a perspective view showing yet another example of the radiator 12. Similar to the radiators 12 shown in FIGS. 8 and 9, the radiators 12 shown in FIG. 10 are formed of a metal plate, such as aluminum, which has a high heat conductivity. A plurality of the convex stripes 12d extending along the height H direction are formed with equal spaces therebetween in the width W direction. The convex stripes 12d are formed so that, when the radiators 12 are buried into areas corresponding to the reaction chambers on the surfaces 11b of the battery case body 11, the convex stripes 12d protrude from the surfaces 11b of the battery case body 11 and align with a surface of the ribs 14 provided on the surfaces 11b. The interval between the convex stripes 12d shown in FIG. 10 is smaller than the interval between the convex stripes 12d provided on the radiators 12 shown in FIGS. 8 and 9.

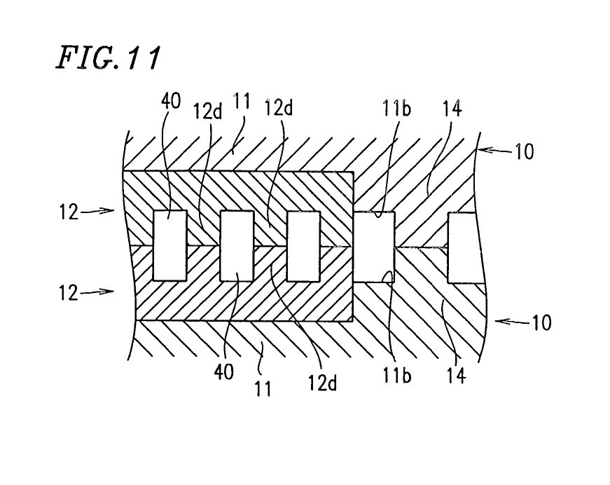

As shown in FIG. 11, when the secondary batteries 100 which comprise the radiators 12 having the above-described structure are stacked side-by-side, the ribs 14 provided on one secondary battery are in contact with those provided on an opposing secondary battery. The convex stripes 12d of one secondary battery are also in contact with those of an opposing secondary battery. Thus, the spaces 40 for passing through the cooling air are formed between a pair of the convex stripes 12d contacting each other and an adjacent pair of the convex stripes 12d contacting each other.

By passing the cooling air through the spaces 40, the radiators 12 are cooled. Since the convex stripes 12d are provided in the radiators 12 shown in FIG. 11, the surface area to be in contact with cooling air increases and the radiators 12 are efficiently cooled.

Moreover, since the cooling air passes through the spaces having the small cross sections defined by the convex stripes 12d provided on the radiators 12, the flow velocity of the cooling air increases, thereby further efficiently cooling the radiators 12.

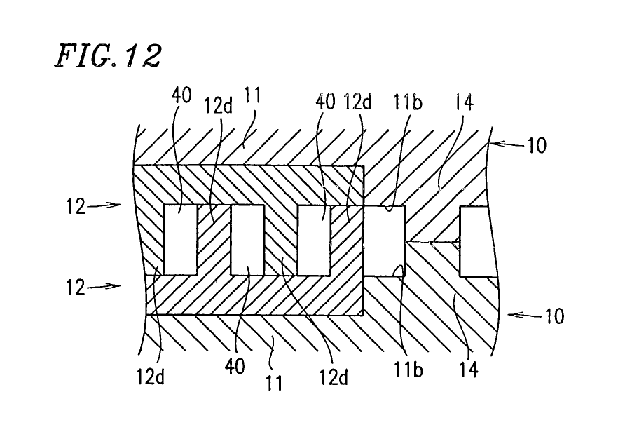

The structure of the convex stripes 12d formed on the radiators 12 is not limited to the structure in which a pair of the convex stripes 12d are in contact with each other when the secondary batteries 100 are stacked side-by-side. Instead, as shown in FIG. 12, the convex stripes 12d may be protruded further to contact the middle portion between two adjacent convex stripes 12d of the opposite radiators 12 rather than the convex stripes 12d of each of the radiators 12 contacting each other.

As described above, the spaces 40 are formed by the convex stripes 12d interdigitated with each other, which are provided on each of the radiators 12 contacting each other. By passing the cooling air through the spaces 40, the radiators 12 are cooled. Since the convex stripes 12d are provided in the radiators 12 shown in FIG. 12, the surface area to be in contact with cooling air flowing through the spaces 40 increases and the radiators 12 are efficiently cooled.

Moreover, since the cooling air passes through the spaces having the small cross sections defined by the convex stripes 12d provided on the radiators 12, the flow velocity of the cooling air increases, thereby further efficiently cooling the radiators 12.

According to the present invention, on the surface of the battery case of the secondary battery, which is formed of a synthetic resin and formed into a thin rectangular-parallelepiped shape, radiators are provided so as to correspond to the respective reaction chambers provided inside the battery case, and thus the reaction chambers are efficiently cooled. As a result, even when the thickness of the battery case is increased due to an increase in the number of the pole plates in the reaction chamber, the temperature rise within the chamber can be suppressed.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. A secondary battery comprising:
a battery case formed of a synthetic resin and formed into a thin rectangular-parallelepiped shape, and whose inner space is divided into a plurality of reaction chambers by walls formed with an appropriate space therebetween in a width direction; and
a plurality of radiators respectively provided on a surface along the width direction of the battery case so as to correspond to the reaction chambers.

2. A secondary battery according to claim 1, wherein each of the radiators is formed of a metal plate which has a high heat conductivity.

3. A secondary battery according to claim 1, wherein the radiators are integrally formed with the battery case by insert molding.

4. A secondary battery according to claim 1, wherein a plurality of grooves extending in the width direction of the battery case and a plurality of grooves extending in a height direction are provided on a surface of each radiator.

5. A secondary battery according to claim 1, wherein each of the radiators is formed of a plurality of radiation pieces located along the width direction of the battery case and the height direction.

6. A secondary battery according to claim 1, wherein each of the radiators comprises a plurality of convex stripes extending in the height direction of the battery case.

7. A secondary battery according to claim 6, wherein the convex stripes of each of the radiators protrude from the surface along the width direction of the battery case.
